(19) United States
(12) Patent Application Publication
(10) Pub. No.: US 2006/0029485 A1
(43) Pub. Date: Feb. 9, 2006

(54) Lock nut assembly

(76) Inventor: Leslie J. Weinstein, Boise, ID (US)

Correspondence Address: Joseph W. Holland;HOLLAND & MIDGLEY, L.L.P., PO Box 1840, Boise, ID, 83701-1840, US

(21) Appl. No.: 10/913,605

(22) Filed: Aug. 5, 2004

(51) Int. Cl. F16B 1/00

(52) U.S. Cl. 411/121

(57) ABSTRACT

A lock nut assembly including a lock plate having a tab that extends into a channel of the shaft, a nut that engages a threaded end of the shaft, a lock ring adapted for placement over the head of the nut and a retainer adapted to fit in a groove formed about the perimeter of the nut to retain the lock ring on the nut. The lock plate and the lock ring include cooperating rotation restriction elements selected from a group of rotation restriction elements including a plurality of apertures and a projecting element insertable into one of the plurality of apertures. The rotation restriction elements of the lock plate and the lock ring cooperatively engage to prohibit rotation or counter rotation of the nut with respect to the shaft.

### BACKGROUND OF THE INVENTION

1. Technical Field

The present invention relates generally to locking fasteners, and more particularly to a lock nut assembly for use on a shaft for retaining a rotating or a rotatable member.

2. Background

Lock nut assemblies are employed generally to provide a more secure means of retaining a variety of mechanical parts in situations where such parts are subject to rotation, vibration or other mechanical forces. Generally speaking, a lock nut assembly includes a threaded nut together with a means for limiting rotation of the nut along a threaded member once the nut has been tightened to a selected torque. A lock nut assembly may be used to secure a rotatable member on a shaft, spindle, axle or other member. A lock nut assembly may also be used for retaining a rotatable member including a wheel assembly on a shaft. The wheel assembly may include a bearing and/or a seal both mountable on the shaft within a race.

The prior art discloses a number of lock nut assemblies that employ an annular lock plate that includes a tab adapted to extend into a longitudinally extending channel of a shaft thereby resisting rotation about the shaft. See for instance, U.S. Pat. Nos. 5,533,794, 5,674,034, 5,795,037, 6,010,290, 6,095,735 and 6,290,442.

The prior art also discloses a number of lock nut assemblies that employ a locking structure that attaches or otherwise cooperates with a nut and an annular lock plate to restrict rotation of the nut on the shaft for instance, U.S. Pat. Nos. 6,290,442, 6,010,290 and 5,795,037.

One challenge faced repeatedly by designers of lock nut assemblies is the adjustability allowed by the assembly. The less, or fewer degrees, a nut must be relative to the shaft before the nut may be locked in position, the closer the assembly comes to permitting infinite adjustability of rotation of the nut while still permitting the nut to be locked against rotation, (or counter-rotation), relative to the shaft. One method employed to lock rotation of a nut relative to a shaft involves inserting a screw through a portion of the lock nut to impinge against an annular lock plate adapted to positively engage a slotted shaft. See U.S. Pat. Nos. 6,290,442 and 5,795,037.

The prior art discloses a variety of lock nut assemblies allowing for varying degrees of adjustability, that is the degrees of rotation required of the nut before the nut can again be locked against rotation with respect to the shaft. For instance, U.S. Pat. No. 1,491,163 discloses a nut lock having a degree of adjustability equal to sixty degrees. U.S. Pat. Nos. 5,395,192 and 5,795,037 disclose locking nut assemblies having a degree of adjustability equal to thirty degrees. U.S. Pat. No. 6,010,290 discloses a locking device permitting a degree of adjustability equal to twenty-two degrees. U.S. Pat. No. 5,533,794 to Faison, entitled Hub Lock, discloses a locking device permitting a degree of adjustability equal to twenty degrees.

Advantage may be found in providing an alternate lock nut assembly that allows a degree of adjustability less than two degrees, approaching infinite while still allowing for a positive engagement between a nut and an annular lock plate adapted to positively engage a slotted shaft. Advantage may be found in providing an alternate lock nut assembly that is suitable for retaining a rotatable member on a shaft or spindle. Additionally, advantage may be found in providing an improved lock nut assembly that provides means for limiting rotation of the nut relative to an annular lock plate that does not result in an increase in the effective diameter of the lock nut assembly and that does not rely on a threaded component to achieve such rotation limiting capability.

### SUMMARY OF THE INVENTION

These and other objects are achieved by a lock nut assembly for use on a shaft having a channel, the lock nut assembly including a nut having an annular portion with a slot extending radially through the annular portion.

The lock nut assembly includes an annular lock plate including a diameter and a tab adapted to extend into the channel of the shaft. The annular lock plate also includes a rotation restriction element selected from a group of rotation restriction elements including a plurality of projecting element engaging apertures and a projecting element insertable into one of the plurality of projecting element engaging apertures. The lock nut assembly also includes a nut adapted for threaded engagement with the shaft. The nut includes a head having a perimeter surface defined by a plurality of connected flats defining a plurality of corners, the nut including a plurality of detents formed on the perimeter surface of the nut. A lock ring includes a head receiving aperture formed through a cross-section of the lock ring that is defined by a plurality of connected flats defining plurality of points. The head receiving aperture is adapted to fit over the head of the nut with the plurality of nut corners received in the points of the lock ring aperture. The lock ring also includes a cooperating rotation restriction element selected from a group of rotation restriction elements including a plurality of projecting elements engaging apertures and a projecting element insertable into one of the plurality of projecting element engaging apertures. A retainer ring is adapted to engage the detents formed on the perimeter surface of the nut to retain the lock ring on the nut with the projecting element inserted into one of the plurality of projecting element engaging apertures. The retainer may be configured as a snap ring, an e-clip, a c-clip, a spiral retainer clip or a pin.

The shaft may be configured either as a solid cylindrical member or a hollow tubular member. The channel may be configured as a keyway having a variety of configurations. The present invention may be implemented on shafts having more than one channel or keyway. In the case that the shaft is configured as a hollow tubular member, the channel may be configured as a slot that extends through a portion of the tube wall.

One embodiment of the invention includes a hub assembly for mounting a rotatable part on a shaft, including a longitudinally extending channel, for instance a wheel assembly on an axle or spindle or the like. The hub assembly includes a housing having an internal diameter, a bearing seat and a bearing assembly positioned within the bearing seat. The hub assembly includes a lock nut assembly according to the present invention for securing the rotatable part on the shaft.

It will be appreciated by those skilled in the art that the various component parts of the lock nut assembly according to the present invention may be formed of a variety of materials including metals and plastics.

Additional advantages and novel features of the invention will be set forth in part in the description that follows, and in part will become apparent to those skilled in the art upon examination of the following, or may be learned by practice of the invention. Additionally, the advantages of the invention may be realized and attained by means of the instrumentalities and combinations particularly pointed out in the appended claims.

### BRIEF DESCRIPTION OF DRAWINGS

FIG. 1 is a perspective representational view of a lock nut assembly according to one preferred embodiment of the present invention;

FIG. 2 is a perspective representational view of a lock nut assembly mounted on a shaft according to one preferred embodiment of the present invention;

FIG. 3 is an exploded perspective representational view of a lock nut assembly according to one preferred embodiment of the present invention;

FIG. 4 is an exploded perspective representational view of a lock nut assembly according to one preferred embodiment of the present invention;

FIG. 5 is a front representational view of an annular lock plate according to one preferred embodiment of the present invention;

FIG. 6 is a front representational view of an annular lock plate according to one preferred embodiment of the present invention;

FIG. 7 is a perspective representational view of a nut according to one preferred embodiment of the present invention;

FIG. 8 is a front representational view of a lock ring according to one preferred embodiment of the present invention;

FIG. 9 is a front representational view of a lock ring according to one preferred embodiment of the present invention;

FIG. 10 is a front representational view of a lock ring according to one preferred embodiment of the present invention;

FIG. 11 is a front representational view of an annular lock plate and a nut positioned on a shaft showing the angular offset between sequential corners of the nut and sequential nubs of the annular lock plate according to one preferred embodiment of the present invention;

FIG. 12 is a front representational view of a lock ring showing the angular offset between sequential points of the lock ring according to one preferred embodiment of the present invention; and

FIG. 13 is a schematic representational view showing one advantage of an octagonal nut as compared to a hex-head nut in use in a lock nut assembly according to one preferred embodiment of the present invention.

### DETAILED DESCRIPTION OF THE INVENTION

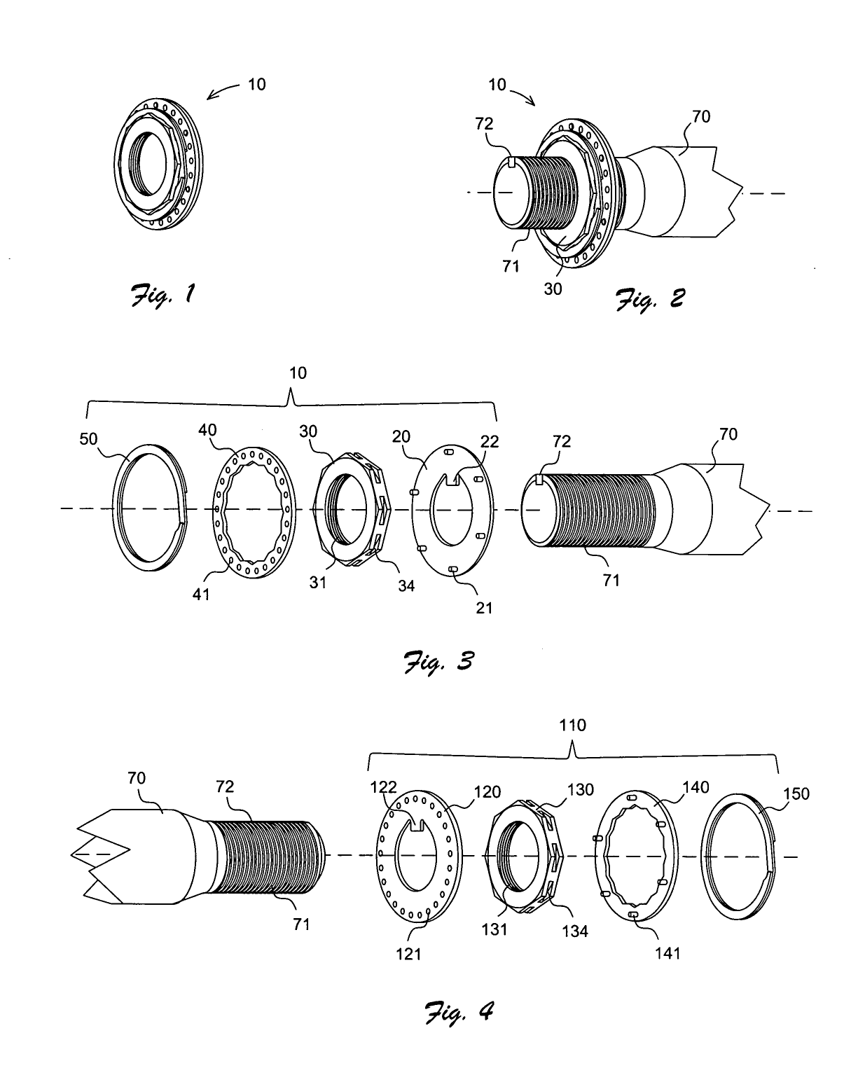

Referring to FIGS. 1-3, lock nut assembly 10 is shown to advantage. Referring to FIG. 2, lock nut assembly 10 is shown assembled on shaft 70. Shaft 70 includes threaded end 71 adapted for threaded engagement with nut 30. Shaft 70 also includes slot 72 which extends longitudinally along at least a portion of a length of threaded end 71 of shaft 70.

Referring to FIG. 3, lock nut assembly 10 is shown in an exploded perspective representational view. Lock nut assembly 10 includes annular lock plate 20, nut 30, lock ring 40 and retainer clip 50. In order to assemble lock nut assembly 10, annular lock plate 20 is positioned on shaft 71 with tab 22 positioned in sliding engagement with slot 72 of shaft 70. Internal thread 31 of nut 30 engages threaded end 71 of shaft 70. Lock ring 40 is positioned over nut 30 such that a projecting element, in this case, nub 21, formed on a face of annular lock plate 20, engages a projecting element engaging aperture 41 formed through a cross-section of lock ring 40. Arranged as such, further rotation or counter-rotation of nut 30 is prohibited. Retainer clip 50 is adapted to engage detents 34 formed on the perimeter surface of nut 30 and maintains contact between mating faces of lock ring 40 and annular lock plate 20.

Referring to FIG. 4, lock nut assembly 110 is shown in an exploded perspective representational view. Lock nut assembly 110 includes annular lock plate 120, nut 130, lock ring 140 and retainer clip 150. In order to assemble lock nut assembly 110, annular lock plate 120 is positioned on shaft 71 with tab 122 positioned in sliding engagement with slot 72 of shaft 70. Internal thread 131 of nut 130 engages threaded end 71 of shaft 70. Lock ring 140 is positioned over nut 130 such that a projecting element, in this case, nub 141, formed on a face of annular lock plate 120, engages a projecting element engaging aperture 121 formed on a face and into a cross-section of annular lock plate 140. Arranged as such, further rotation or counter-rotation of nut 130 is prohibited. Retainer clip 150 is adapted to engage detents 134 formed on the perimeter surface of nut 130 to maintain contact between mating faces of lock ring 140 and annular lock plate 120.

Referring to FIG. 5, annular lock plate 20 is shown including tab 22 which extends radially within aperture 24 formed through a cross-section of annular lock plate 20. In the preferred embodiment, at the locations at which tab 22 extends from annular lock plate 20 such locations include radiused corners 23. Annular lock plate 20 includes a plurality of nubs 21 which are formed on face 25 of annular lock plate 20 by conventional means including machining or punching or semi-piercing.

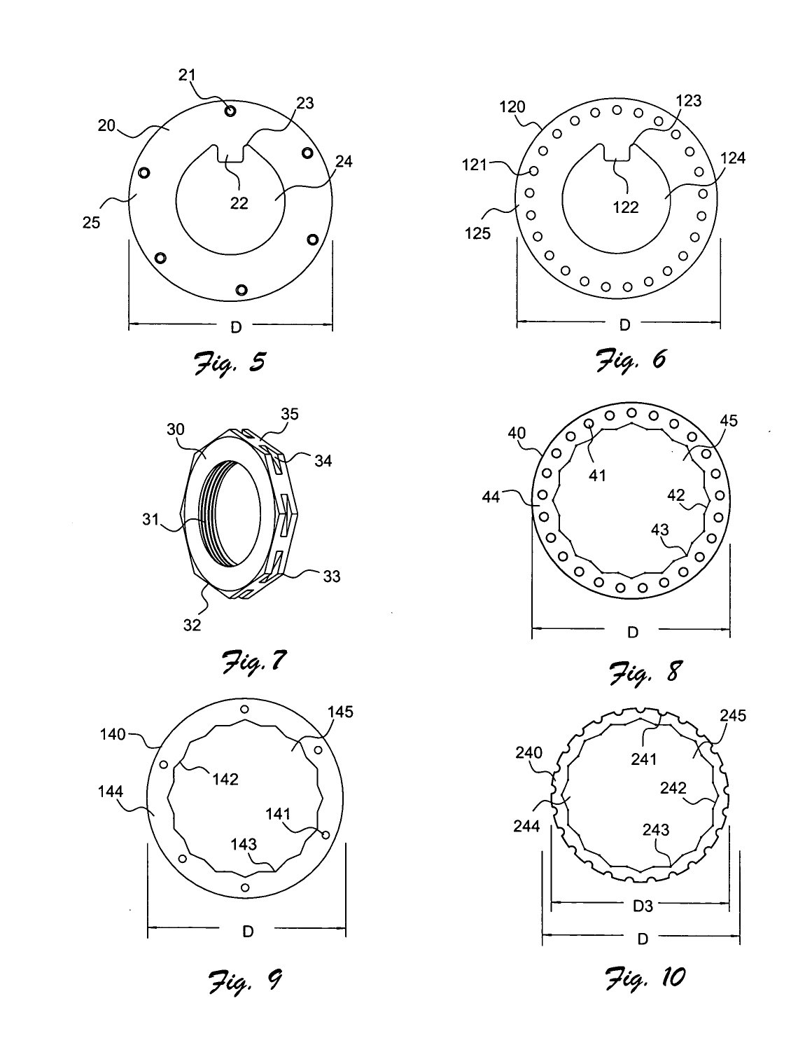

FIG. 6, shows an alternate embodiment of annular lock plate 120 that includes tab 122 which extends radially within aperture 124 formed through a cross-section of annular lock plate 120. In the embodiment shown, at the locations at which tab 122 extends from annular lock plate 120, such locations include radiused corners 123. Annular lock plate 120 also includes a plurality of projecting element engaging apertures 121, formed in face 125 and projecting into a thickness of annular lock plate 120.

FIG. 7, is a perspective representational view of nut 30 including internal thread 31. As shown nut 30 includes octagonal perimeter surface 35 which is defined by a plurality of connected flats 32 intersecting and defining a plurality of corners 33. Nut 30 also includes a plurality of detents 34 formed on perimeter surface 35 of nut 30.

Referring to FIG. 8, lock ring 40 including diameter D. Head receiving aperture 45 is formed through a cross-section of lock ring 40. Head receiving aperture 45 is defined by a plurality of connected flats 42 that define a plurality of points 43. Head receiving aperture 45 is adapted to fit over a nut 30, as seen in FIG. 3. Lock ring 40 also includes a rotation restriction element which, in the case of the lock ring 40 shown in FIG. 8, is configured a plurality of projecting element engaging apertures 41 which project into face 44 and through a cross-section of lock ring 40. As seen in FIG. 8, lock ring 40 is adapted for placement over a nut such as that shown in FIG. 7 having an octagonal head, lock ring 40 having a number of connected flats 42 that define a plurality of points 43 that is a multiple of the number of connected flats 32 defining a plurality of corners 33 of nut 30, seen in FIG. 7.

FIG. 9 shows an alternate embodiment of lock ring 140 including diameter D. Head receiving aperture 145 is formed through a cross-section of lock ring 140. Head receiving aperture 145 is defined by a plurality of connected flats 142 that define a plurality of points 143. Head receiving aperture 145 is adapted to fit over a nut 130, as seen in FIG. 4. Lock ring 140 also includes a rotation restriction element which, in the case of the lock ring 140 shown in FIG. 9, is configured as a plurality of projecting element engaging elements 141, formed on face 144.

FIG. 10 shows an alternate embodiment of lock ring 240 including diameter D3 that is less than a diameter D. Head receiving aperture 245 is formed through a cross-section of lock ring 240. Head receiving aperture 245 is defined by a plurality of connected flats 242 that define a plurality of points 243. Head receiving aperture 245 is adapted to fit over a nut. Lock ring 240 also includes a rotation restriction element which, in the case of the lock ring 240 shown in FIG. 10, is configured a plurality of projecting element engaging apertures 241 which are formed as slots that project into face 244 and through a cross-section of lock ring 240.

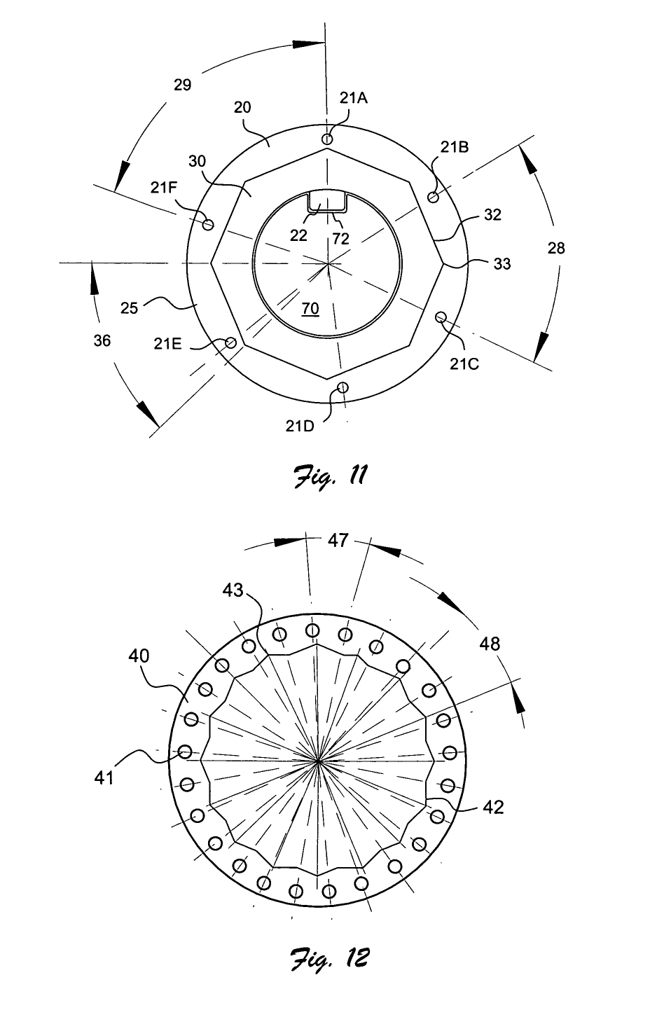

Referring to FIGS. 11 and 12, it will be observed that a unique relationship exists between:
a) As seen in FIG. 11, a number of flats 32 and corners 33 defining the perimeter of nut 30, (i.e., octagonal having an even number, eight, flats and corners, resulting in 45 degrees of rotation or angular offset 36 between sequential corners 33),
b) As seen in FIG. 12, a number of flats 42 and points 43 defining the aperture of lock ring 40, (i.e., an even number, sixteen, flats and points in the embodiment shown, resulting in 22.5 degrees of rotation or angular offset 48 required to reposition the lock ring on nut 30),
c) As seen in FIG. 12, a number of projecting element engaging apertures 41 located on the face 44 of lock ring 40, (i.e., an odd number 25, resulting in 14.4 degrees of rotation or angular offset 47 between sequential apertures 41), and
d) As seen in FIG. 11, a number of nubs 21A through 21F formed on a face 25 of annular lock plate 20, (i.e. 6, an even number, having an irregular angular offset. As shown angular offset 28, which is the same between sequential nubs 21A to 21B, 21B to 21C, 21C to 21D, 21D to 21E and 21E to 21F, or in this case approximately 58.5°, while angular offset 29 between sequential nubs 21F to 21A is substantially equal to 67.5°.)

As seen in FIG. 11, lock washer 20 and nut 30 are positioned on shaft 70 with tab 22 of lock washer 20 engaging channel 72 of shaft 70. Nut 30 includes an octagonal configuration having eight flats 33 and corners 32.

A differentiation is created by the differing angular offsets observed between sequential points 43 defining the aperture of lock ring 40, equal to 22.5 degrees of rotation or angular offset 48 and sequential apertures 41 of lock ring 40, which exhibit 14.4 degrees of rotation or angular offset 49 between sequential apertures 41. As such, apertures 41 seldom lie co-radially to corners 43 and as such, each time lock ring 40 is re-positioned nut 30, a separate and distinct probability exists that apertures 41 will engage nubs 21 formed on a face of annular lock plate 20. At least two separate observations are significant with respect to the described feature. First, the angular offset between any given corner 33 and the closest aperture 41 will be in the range of zero degrees to one half the angular offset between sequential corners. For instance, where the angular offset between sequential corners 33 equals 22.5 degrees, the angular offset between any given corner 33 and the closest aperture 41 will be in the range of zero degrees to one half of 22.5 degrees, or 0 to 11.25 degrees, and each time lock ring 40 is advanced to fit on the nut, one of several possible relationships of apertures 41 to nubs 21 is presented. In the embodiment shown, it has been observed that for any given rotational advance of nut 30 on shaft 70, there are sixteen possible positions for lock ring 40 over nut 30 and no fewer that five of these positions will result in engagement of nubs 21 with apertures 41. Additionally, because of the differing angular offsets observed between sequential points 43 and sequential apertures 41 of lock ring 40, lock ring 40 may be flipped over so that nubs 21 engage apertures 21 from a second face of lock ring 40 effectively doubling the possible positions wherein nubs 21 engage apertures 41. The result is a lock nut assembly 10 that allows for adjustability of nut 30 on shaft 70 in the range of 2 degrees approaching infinite, if in fact not infinite, while still permitting locking of nut 30 on shaft 70 to secure against rotation or counter-rotation after setting a desired torque.

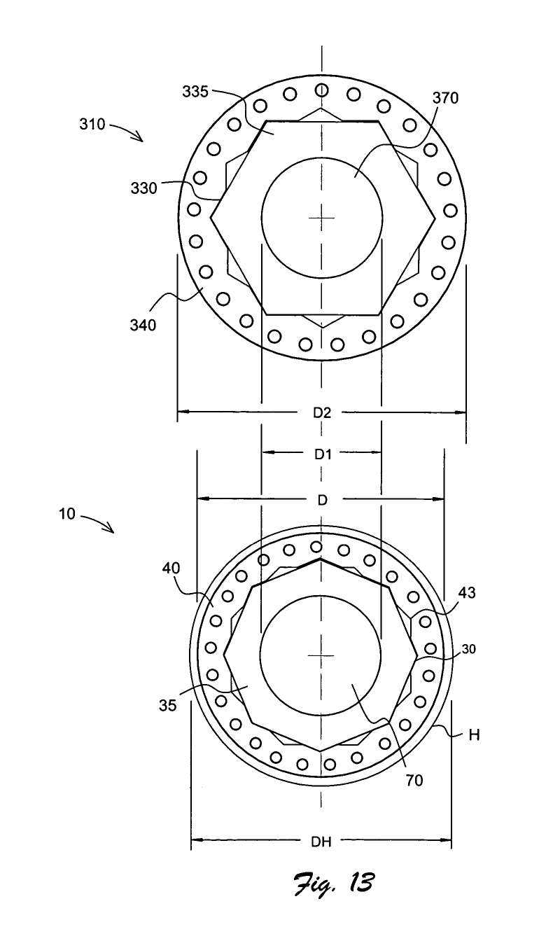

FIG. 13 is a schematic representational view showing an advantage of employing an octagonal nut 30 as compared to a hex-head nut 330 in a lock nut assembly 10 and 310 respectively. Octagonal nut 30 and hex-head nut 330 are adapted to engage a shaft 70 and 370 respectively each having a diameter equal to Dl. Lock ring 40 is adapted to be placed over head 35 of octagonal nut 30. Lock ring 40 has a diameter equal to D. Similarly, lock ring 340 is adapted to be placed over head 335 of octagonal nut 330. Lock ring 340 has a diameter equal to D2. As can be seen, the use of an octagonal nut in the above application results in a substantial reduction in overall diameter of a lock nut assembly. This advantage may be of particular significance in those applications where a lock nut assembly is employed to retain a bearing that is seated in a housing H having a diameter DH that is greater than D and less than a diameter D2 of lock ring 340.

It is to be understood that the invention is not limited to the embodiment shown and described above. Various other embodiments of the invention may be made and practiced without departing from the scope of the invention, as defined in the following claims.

1. A lock nut assembly for use on a shaft including a threaded end and a channel, the lock nut assembly comprising:
an annular lock plate including a diameter and a tab adapted to extend into the channel of the shaft;
the annular lock plate including a rotation restriction element selected from a group of rotation restriction elements including a plurality of projecting element engaging apertures and a projecting element insertable into one of the plurality of projecting element engaging apertures;
a nut adapted for threaded engagement with the shaft, the nut including a head having a perimeter surface defined by a plurality of connected flats defining a plurality of corners, the nut including a plurality of detents formed on the perimeter surface of the nut;
a lock ring including a diameter, the lock ring including a head receiving aperture formed through a cross-section of the lock ring, the head receiving aperture defined by a plurality of connected flats defining plurality of points, the head receiving aperture adapted to fit over the nut with the plurality of nut corners received in the plurality of points of the lock ring aperture. a total number of the plurality of connected flats of the lock ring equal to two or more times a number of the plurality of connected flats of the nut;
the lock ring including a cooperating rotation restriction element selected from a group of rotation restriction elements including a plurality of projecting element engaging apertures and a projecting element insertable into one of the plurality of projecting element engaging apertures; and
a retainer ring adapted to engage the detents formed on the perimeter surface of the nut.

2. A lock nut assembly for use on a shaft including a threaded end and a channel, the lock nut assembly comprising:
an annular lock plate including a diameter and a tab adapted to extend into the channel of the shaft;
the annular lock plate a projecting element formed on a face of the annular lock plate;
a nut adapted for threaded engagement with the shaft, the nut including a head having a perimeter surface defined by a plurality of connected flats defining a plurality of corners, the nut including a plurality of detents formed on the perimeter surface of the nut;
a lock ring including a diameter, the lock ring including a head receiving aperture formed through a cross-section of the lock ring, the head receiving aperture defined by a plurality of connected flats defining plurality of points, the head receiving aperture adapted to fit over the nut with the plurality of nut corners received in the plurality of points of the lock ring aperture, a total number of the plurality of connected flats of the lock ring equal to two or more times a number of the plurality of connected flats of the nut;
the lock ring including a plurality of projecting element engaging apertures formed in a face of the lock ring and projecting into a thickness of the lock ring, the projecting element of the annular lock plate insertable into one of the plurality of projecting element engaging apertures; and
a retainer ring adapted to engage the detents formed on the perimeter surface of the nut.

3. The lock nut assembly of claim 2 further comprising:
the nut including a polygonal head including a plurality of flats; and
the head-receiving aperture of the lock ring is defined by a plurality of connected flats equal to a multiple of a number of the plurality of flats defining the outer perimeter of the head of the nut.

4. The lock nut assembly of claim 2 further comprising:
the nut including a hexagonal head including six connected flats defining six corners; and
the head-receiving aperture of the lock ring is defined by a number of connected flats equal to a multiple of six defining a number of points equal to a multiple of six.

5. The lock nut assembly of claim 2 further comprising:
the nut including an octagonal head including eight connected flats defining eight corners; and
the head-receiving aperture of the lock ring is defined by a number of connected flats equal to a multiple of eight defining a number of points equal to a multiple of eight.

6. The lock nut assembly of claim 2, wherein the lock ring further comprises the head receiving aperture defined by a plurality of connected flats equal to a multiple of a number of the plurality of connected flats defining the plurality of corners of the perimeter surface of the nut.

7. The lock nut assembly of claim 2, wherein the projecting element engaging apertures further comprise a plurality of slots formed through a cross-section of the annular lock plate.

8. The lock nut assembly of claim 2, wherein the projecting element further comprise a plurality of nubs formed on and projecting form a face of the lock ring.

9. The lock nut assembly of claim 2 further comprising the diameter of the lock ring including a dimension that is less than or equal to diameter of the diameter of the annular lock plate.

10. The lock nut assembly of claim 2 further comprising:
the nut including a polygonal head including an even number of flats;
the head receiving aperture of the lock ring is defined by a plurality of connected points equal to the even number of flats of the nut times a whole number;
the plurality of projecting element engaging apertures formed in a face of the lock ring and projecting into a thickness of the lock ring is equal to an odd number of projecting element engaging apertures; and
a rotational offset between sequential connected points defining the head-receiving aperture of the lock ring and sequential projecting element engaging apertures.

11. A lock nut assembly for use on a shaft including a threaded end and a channel, the lock nut assembly comprising:
an annular lock plate including a diameter and a tab adapted to extend into the channel of the shaft;
the annular lock plate including a plurality of projecting element engaging apertures formed in a face and projecting into a thickness of the annular lock plate;
a nut adapted for threaded engagement with the shaft, the nut including a head having a perimeter surface including a plurality of connected flats defining a plurality of corners, the nut including a plurality of detents formed on the perimeter surface of the nut;
a lock ring including a diameter, the lock ring including a head receiving aperture formed through a cross-section of the lock ring, the head receiving aperture defined by a plurality of connected flats defining plurality of points, the head receiving aperture adapted to fit over the nut with the plurality of nut corners received in the plurality of points of the lock ring aperture;
the lock ring including a projecting element insertable into one of the plurality of projecting element engaging apertures formed through a cross-section of the annular lock plate; and
a retainer ring adapted to engage the detents formed on the perimeter surface of the nut.

12. The lock nut assembly of claim 11 further comprising:
the nut including a polygonal head including a plurality of flats; and
the head-receiving aperture of the lock ring is defined by a plurality of connected flats equal to a multiple of a number of the plurality of flats defining the outer perimeter of the head of the nut.

13. The lock nut assembly of claim 11 further comprising:
the nut including a hexagonal head including six connected flats defining six corners; and
the head-receiving aperture of the lock ring is defined by a number of connected flats equal to a multiple of six defining a number of points equal to a multiple of six.

14. The lock nut assembly of claim 11 further comprising:
the nut including an octagonal head including eight connected flats defining eight corners; and
the head-receiving aperture of the lock ring is defined by a number of connected flats equal to a multiple of eight defining a number of points equal to a multiple of eight.

15. The lock nut assembly of claim 11, wherein the lock ring further comprises the head receiving aperture defined by a plurality of connected flats equal to a multiple of a number of the plurality of connected flats defining the plurality of corners of the perimeter surface of the nut.

16. The lock nut assembly of claim 11, wherein the projecting element engaging apertures further comprise a plurality of slots formed through a cross-section of the lock ring.

17. The lock nut assembly of claim 11, wherein the projecting element further comprise a plurality of nubs formed on and projecting form a face of the annular lock plate.

18. The lock nut assembly of claim 11 further comprising the diameter of the lock ring including a dimension that is less than or equal to diameter of the diameter of the annular lock plate.

19. The lock nut assembly of claim 11 further comprising:
the nut including a polygonal head including an even number points connecting an even number of flats;
the head receiving aperture of the lock ring is defined by an even number of flats connecting an even number of corners, the even number of flats and the even number of corners equal to the even number points of the nut times a whole number;
the plurality of projecting element engaging apertures formed in a face of the lock ring and projecting into a thickness of the lock ring is equal to an odd number of projecting element engaging apertures; and
a rotational offset between sequential connected points defining the head-receiving aperture of the lock ring and sequential projecting element engaging apertures.
